(19) United States
(12) Patent Application Publication
(10) Pub. No.: US 2018/0251645 A1
(43) Pub. Date: Sep. 6, 2018

(54) 3D POLYMERIZABLE CERAMIC INKS

(71) Applicant: Yissum Research Development Company of the Hebrew University of Jerusalem Ltd, Jerusalem (IL)

(72) Inventors: Shlomo MAGDASSI, Jerusalem (IL); Ido COOPERSTEIN, Haifa (IL); Efrat SHUKRUN, Jerusalem (IL)

(73) Assignee: Yissum Research Development Company of the Hebrew University of Jerusalem Ltd, Jerusalem (IL)

(21) Appl. No.: 15/753,722

(22) PCT Filed: Aug. 18, 2016
(86) PCT No.: PCT/IL2016/050908

§ 371 Date: Feb. 20, 2018

Related U.S. Application Data
(60) Provisional application No. 62/207,113, filed on Aug. 19, 2015.
(60) Provisional application No. 62/207,433, filed on Aug. 20, 2015.

(51) Int. Cl. C09D 11/101; C08K 3/08

(52) U.S. Cl. CPC C09D 11/101; B28B 1/001; C08K 3/08

(57) ABSTRACT

Provided are formulations and processes for manufacturing 3D objects, the formulations being free of particulate materials and used in low temperature 3D printing processes.

### TECHNOLOGICAL FIELD

The invention generally concerns formulations for 3D printing and processes for constructing 3D objects.

### BACKGROUND

Three dimensional (3D) printing technologies are based on forming a 3D structure by printing 2D layers one on top of the other. The additive manufacturing process can be performed by various methods, such as fuse deposition modeling (FDM)—extruding of polymers through a nozzle, printing of a binder on powder of various material (3dp), selective laser sintering (SLS)—sintering of polymeric powder by laser, direct metal laser sintering (DMLS)—sintering of metal powder by laser, laminated object manufacturing (LOM)—gluing and cutting of material sheets by a knife or a laser, direct writing—jetting liquid through a nozzle and stereolithography (SLA)—selective curing of monomers. These techniques enable the printing of 3D structures with different mechanical properties and from various materials such as polymers, metals, food, cement and ceramics.

Currently, forming a ceramic 3D structure by 3D printing is achieved mainly in a two-stage fabrication process, which involves: first printing a ceramic green body, which is composed of a ceramic powder or sheets and a binder, followed by sintering of the green body at a high temperature. This fabrication method can be done by various methods known in the art. There have been reports on printing ceramic parts, such as silica sand (that possesses some percentage of Al₂O₃ that reduces the sintering temperature) and soda glass, by a one-stage 3D printing. This kind of printing can be achieved only by selective laser sintering/melting technique and it is not wildly use.

Industrial ceramic 3D printing is mainly based on using ceramic particles. For example, by the DLP technique with the printer CeraFab 7500 of Lithoz GmbH, inks composed of ceramic particles dispersed in monomers can be printed. Furthermore, Organic filaments are available that contain ceramic materials for FDM printing. The ceramics that can be printed are aluminum oxide, tricalcium phosphate, zirconium oxide, bio glass, and others. Silica printing can also be performed by printing binders on silica sand or on soda glass powder in the 3dp techniques as with the printers of ExOne.

Another approach is by SLA printing of liquid polymerizable inks, composed of monomers, photoinitiators and dispersed ceramic particles. The polymerization is triggered by localized light radiation. Such a process, with this type of ink, is problematic since, in order to achieve a 3D structure with high content of the ceramic material (silica), it is required to utilize an ink with a high concentration of the ceramic particles. Such inks are turbid due to light scattering, which has a critical negative effect on the light-induced polymerization process. This requirement limits the use of SLA in making ceramic objects.

SLA 3D printing technologies are based on bottom-up fabrication by selective polymerizing of monomers, by light irradiation. The fabrication of the object is mainly done by digital Light Processing (DLP), in which the ink is present in a bath and the light source is focused at various spots, or by ink-jet printing in which each ink-jet printed layer is exposed to UV radiation. The SLA 3D ink formulations are typically composed of monomers or oligomers in liquid form, with dissolved photo-initiators which are activated by a light source, usually in the UV range.

### REFERENCES

[1] Travitzky, N.; Bonet, A.; Dermeik, B.; Fey, T.; Filbert-Demut, I.; Schlier, L.; Schlordt, T.; Greil, P., Additive Manufacturing of Ceramic-Based Materials. Advanced Engineering Materials 2014, 16 (6), 729-754.
[2] Tang, Y.; Fuh, J. Y. H.; Loh, H. T.; Wong, Y. S.; Lu, L., Direct laser sintering of a silica sand. Materials & Design 2003, 24 (8), 623-629.
[3] Fateri, M.; Gebhardt, A., Selective Laser Melting of Soda-Lime Glass Powder. International Journal of Applied Ceramic Technology 2015, 12 (1), 53-61.
[4] Felzmann, R.; Gruber, S.; Mitteramskogler, G.; Tesavibul, P.; Boccaccini, A. R.; Liska, R.; Stampfl, J., Lithography-Based Additive Manufacturing of Cellular Ceramic Structures. Advanced Engineering Materials 2012, 14 (12), 1052-1058.
[5] http://www.lithoz.com/en/[6]
[6] http://www.exone.com/
[7] Mitteramskogler, G.; Gmeiner, R.; Felzmann, R.; Gruber, S.; Hofstetter, C.; Stampfl, J.; Ebert, J.; Wachter, W.; Laubersheimer, J., Light curing strategies for lithography-based additive manufacturing of customized ceramics. Additive Manufacturing 2014, 1-4, 110-118.
[8] Yu, Y.-Y.; Chen, C.-Y.; Chen, W.-C., Synthesis and characterization of organic—inorganic hybrid thin films from poly(acrylic) and monodispersed colloidal silica. Polymer 2003, 44 (3), 593-601.
[9] Corcione, C. E.; Striani, R.; Frigione, M., Organic—inorganic UV-cured methacrylic-based hybrids as protective coatings for different substrates. Progress in Organic Coatings 2014, 77 (6), 1117-1125.

### SUMMARY OF THE INVENTION

As a person of skill would realize, a major parameter affecting printing time and quality is the ability to light, such as UV to penetrate through a printing formulation and induce polymerization or other reactivity to in-depth layers of a printed pattern. As thicker printing layers do not permit light to penetrate the full thickness of the layer, and as light scattering effects impose a negative impact on printing processes, printing times, resolutions and efficiencies become greatly reduced. In addition, as the majority of ceramic inks contain dispersed particles, suspension stability, particle aggregation and sedimentation also negatively affect and complicate ink preparation and application process.

To overcome many of the deficiencies present in the use of formulations for the construction of ceramic and glass materials, the inventors of the technology disclosed herein have developed a novel methodology which allows for a facile low temperature printing of ceramic materials, which is based on polymerizable solutions, and which renders unnecessary the use of particulate materials. The processes of the invention are efficient and provide ceramic objects with tailored properties.

The process of the invention allows to increase printing layer thickness and printing ink reactivity, dramatically reducing printing time at a given dose of light source intensity, and temperatures of application. This is achievable by providing transparent or semi-transparent ink formulations that are not formed from or comprise dispersed ceramic particles, but rather are formed from organic and/or organometallic materials, such as hybrid molecules containing metal-alkoxide and organic UV-curable groups. The formulations enable formation of transparent or opaque ceramic 3D objects or objects made of organic/ceramic hybrids.

The ink formulations of the invention enable rapid formation of 3D objects by printing processes which involve hybrid polymerizable materials (monomers, oligomers or pre-polymers) having a dual mechanism: they polymerize under light irradiation to form the 3D objects and also convert, e.g., by polymerization, into ceramic bodies upon when post-treated to remove the organic material. The hybrid precursors of the invention are polymerizable ceramic precursors in the form of monomers, oligomers or pre-polymers of ceramic materials. In other words they are precursors of at least one ceramic material having at least one photopolymerizable functional group. The inks are composed of hybrid molecules or of combinations of such hybrid molecules and ceramic precursors.

Thus, in a first aspect, the invention provides a polymerizable ceramic precursor having the general formula A-B, wherein:

A is a ceramic precursor moiety (namely a precursor of a ceramic material), and B is at least one photopolymerizable group (namely a functional group which is reactive under light radiation to polymerize);

wherein B is associated with or bonded to A via a chemical bond designated by “-” (covalent bond, complex, ionic bond, H-bonding).

In some embodiments, A is a ceramic precursor moiety capable of converting under specified conditions to a ceramic material or a glass. The ceramic precursor may be in a form selected from monomers, oligomers and pre-polymers of at least one ceramic material, as known in the art.

In some embodiments, A is a monomer (or an oligomer thereof or a pre-polymer thereof) selected from tetraethyl orthosilicate, tetramethyl ortosilicate, tetraisopropyl titanate, trimethoxysilane, triethoxysilane, trimethyethoxysilane, phenyltriethoxysilane, phenylmethyldiethoxy silane, methyldiethoxysilane, vinylmethyldiethoxysilane, TES 40; polydimethoxysilane, polydiethoxysilane, polysilazanes, titanium isopropoxide, aluminum isopropoxide, zirconium propoxide, triethyl borate, trimethoxyboroxine diethoxysiloxane-ethyltitanate, titanium diisopropoxide bis(acetylacetonate), silanol poss, aluminium tri-sec-butoxide, triisobutylaluminium, aluminium acetylacetonate, 1,3,5,7,9-pentamethylcyclo pentasiloxane, poly(dibutyltitanate) oligomers of siloxane, and oligomers of Al—O—Al, oligomers of Ti—O—Ti and/or Zn—O—Zn.

In some embodiments, B is at least one photopolymerizable group chemically bonded to A. B may be any material having at least one group or moiety which undergoes polymerization under light radiation. Such groups or moieties may be selected from amines, thiols, amides, phosphates, sulphates, hydroxides, alkenes and alkynes.

In some embodiments, the photopolymerizable group is selected from organic moieties comprising one or more double or triple bonds. In some embodiments, the organic polymerizable group is selected amongst alkenyl groups and alkynyl groups. In some embodiments, the photopolymerizable group is selected from acryloyl groups, methacryloyl groups, vinyl groups, epoxy groups and thiol group.

Thus, the photopolymerizable ceramic precursors according to the invention are ceramic precursors, as defined, modified, substituted, bonded or associated with a polymerizable group selected as above, e.g., from amines, thiols, amides, phosphates, sulphates, hydroxides, epoxy, alkenes and alkynes; wherein in some embodiments, the photopolymerizable group is selected from alkenyl groups, acryloyl groups, methacryloyl groups, vinyl groups, epoxy group and thiol group.

In another aspect, the invention provides a printing formulation (an ink or an ink formulation), in the form of a solution, comprising:
a plurality of polymerizable ceramic precursors having the structure A-B, as defined,
optionally a plurality of non-photopolymerizable ceramic precursors (namely, precursor of a ceramic material that are not associated with a photopolymerizable moiety);
at least one photoreactive compound capable of initiating a reaction upon light radiation (at least one photoinitiator);

and
optionally at least one liquid organic carrier.

In some embodiments, the formulation is free of ceramic particles of any size (nanoparticles or micro particles). In some embodiments, the formulation is free of any particulate material.

In some embodiments, at least one of the formulation components is a liquid material at room temperature or at the application (printing) temperature and thus the formulation may be free of a liquid carrier. In some embodiments, the formulation comprises at least one liquid carrier, being optionally a liquid organic solvent or material.

As noted, formulations according to the invention are solutions which may be used as inks or ink formulations to construct a 3D structure according to processes of the invention. In formulations of the invention, all components are fully soluble in the at least one liquid organic carrier or in at least one of the components of the formulations which is in a liquid form. The solution being transparent or slightly opaque.

In some embodiments, the formulation comprises a plurality of polymerizable ceramic precursors of the formula A-B which are photopolymerizable into a polymer in the form of a ceramic material such that each of said A groups or at least a portion of said A groups along the polymer are substituted, bonded or associated with at least one group B. Thus, such a formulation according to the invention may comprise a plurality of polymerizable ceramic precursors of the formula A-B, as defined, as the only polymerizable precursor material, in which case a polymerized material will consist only of monomers of the structure A-B, as defined, or may comprise an amount or a certain pre-defined percentage of ceramic precursors which are free of polymerizable groups. In such cases, a formulation according to the invention may comprise:
a plurality of polymerizable ceramic precursors having the structure A-B, as defined,
a plurality of ceramic precursors (not being associated with a polymerizable moiety);
at least one photoinitiator;
   and
optionally at least one liquid organic carrier,

the formulation being in solution form.

In some embodiments, the polymerizable ceramic precursors of the formula A-B are selected from (acryloxypropyl)trimethoxysilan (APTMS), 3-glycidoxypropyl methyldiethoxysilane, acryloxymethyltrimethoxysilane, (acryloxymethyl)phenethyl trimethoxysilane, (3-acryloxypropyl)trichlorosilane, 3-(n-allylamino)propyltrimethoxy silane, m-allylphenylpropyltriethoxysilane, allyltrimethoxysilane, 3-glycidoxypropyl methyldiethoxysilane, 3-glycidoxypropyl methyldiethoxysilane and POSS acrylates (polyhedral oligomeric silsesquioxane modified with acrylate or methacrylate groups such as methacryl POSS, acrylo POSS, epoxy POSS, allyisobutyl POSS, vinyl POSS, thiol POSS, and others).

In some embodiments, the polymerizable ceramic precursors of the formula A-B are selected from (acryloxypropyl)trimethoxysilan (APTMS) and POSS acrylates, as defined.

In some embodiments, the ceramic precursors which are free of photopolymerizable groups are selected from tetraethoxyorthosilicate, tetraisopropyltitanate, trimethoxysilane, polydiethoxysilane, polydimethoxysilane, polysilazanes triethoxy silane, trimethyethoxysilane, phenyltriethoxysilane, phenylmethyldiethoxysilane, methyl diethoxysilane, TES 40, tetraethyl orthosilicate (TEOS), titanium isopropoxide, aluminum isopropoxide, zirconium propoxide, triethyl borate, trimethoxyboroxine diethoxysiloxane-ethyltitanate, titanium diisopropoxide bis(acetylacetonate), silanol POSS, aluminium tri-sec-butoxide, triisobutylaluminium, aluminium acetylacetonate, 1,3,5,7,9-pentamethylcyclopentasiloxane, poly(dibutyl titanate) oligomers of siloxane, oligomers of Al—O—Al, and oligomers of Ti—O—Ti, Zn—O—Zn, and others.

In some embodiments, the ink formulation comprises (acryloxypropyl) trimethoxysilan (APTMS) and POSS (polyhedral oligomeric silsesquioxane) modified with acrylate or methacrylate groups, such as methacryl POSS and acrylo POSS, (e.g., produced by hybrid-plastics, or initially prepared at required ratios with polymerizable monomers).

In some embodiments, the ink formulation further comprises at least one metal alkoxide selected from titanium isopropoxide, aluminum isopropoxide, zirconium propoxide, triethyl borate, trimethoxyboroxine diethoxysiloxane-ethyltitanate, titanium diisopropoxide bis(acetylacetonate), silanol poss, aluminium tri-sec-butoxide, triisobutyl aluminium, aluminium acetylacetonate, 1,3,5,7,9-pentamethylcyclo pentasiloxane and poly(dibutyltitanate).

A unique property of ink formulations of the present invention is their ability to form 3D objects having a high heat deflection temperature or heat distortion temperature (HDT). As known in the art, the HDT of most 3D printed plastics is too low, bringing a major challenge for many applications based on printed objects. The printed objects of the invention have high HDT, typically above 120° C., due to the very dense structure of the objects, controllable by changing the ratio between the organic and inorganic components of the ink formulation and by one or more post treatments, mainly thermal treatments, that the printed objects may undergo.

In other embodiments, the ink formulations of the invention comprise (acryloxypropyl) trimethoxysilan (APTMS) and POSS acrylate (polyhedral oligomeric silsesquioxane modified with acrylate or methacrylate groups, such as methacryl POSS, and acrylo POSS, or initially prepared at the required ratios with polymerizable monomers that can possess other atoms besides carbon such as nitrogen, sulfur and oxygen). In some embodiments, the ink formulation may comprise other metal alkoxides such as titanium isopropoxide, aluminum isopropoxide, zirconium propoxide, triethyl borate and others.

In other embodiments, the ink formulations comprise oligomers of siloxane or oligomers with Al—O—Al, Ti—O—Ti backbones and mixtures thereof, and an amount of polymerizable ceramic precursors of the formula A-B, thus providing an ink formulation enabling transparent ceramic glass 3D structures. This can be achieved by sol-gel processing with precursors such as tetraethyl orthosilicate (TEOS), titanium isopropoxide, aluminum isopropoxide, zirconium propoxide, triethyl borate, etc., in presence of appropriate concentration of hybrid monomers of the invention, such as (acryloxypropyl)trimethoxysilan (APTMS). In such embodiments, the ink formulation may be prepared by acidic hydrolysis followed by basic condensation. After printing and exposure to light (for example by DLP printer, causing photopolymerization), the structure is kept sealed for aging and then dried to remove excess of water and alcohol. For achieving silica glass (without, or with traces of organic materials), the structure may be heated to elevated temperatures, depending on the ink composition. Further heat treatment may be required to obtain sintering of the ceramic body and/or to obtain a transparent glass.

In other embodiments, the ink formulations comprise oligomers of siloxane or oligomers of Al—O—Al, Ti—O—Ti backbones, and an amount of the hybrid monomers of the invention, along with alkali metals such sodium, calcium potassium etc., present to reduce the melting point. This formulation enables achieving transparent glass 3D structures. This can be achieved by sol gel processing with precursors such as tetraethyl orthosilicate (TEOS), titanium isopropoxide, aluminum isopropoxide, zirconium propoxide, triethyl borate etc., in presence of an appropriate concentration of hybrid monomers, such as (acryloxypropyl)trimethoxysilan (APTMS), and metal precursors such as sodium nitrate, sodium acetate, calcium nitrate, trisodium phosphate, sodium benzoate, etc., and other additives known for reducing the melting point of glass such as phosphates and borates. The process is conducted by hydrolysis under acidic conditions and is continued by condensation under basic conditions. After printing, the structure is kept sealed for aging and then dried to remove excess of water and alcohol. For achieving silica glass, the structure may be heated to temperature about 600° C. for removing excess of carbon and sintering of the glass, and further heat treatment may be performed, according to the glass composition.

The formulation of the invention comprises at least one photoreactive material, namely at least one photoinitiator. In some embodiments, the at least one photoinitiator is capable of generating a radical, an acid or a base with irradiation of a light having a wavelength of 300 to 900 nm.

In some embodiments, the at least one photoinitiator is capable of generating a radical species under light irradiation. In some embodiments, the at least one photoinitiator is a cationic photoinitiator.

In some embodiments, the at least one photoinitiator is capable of generating an acid.

In some embodiments, the at least one photoinitiator is selected from triphenyl sulfonium triflate, trimethyldiphenylphosphineoxide, TPO, 2-hydroxy-2-methyl-1-phenyl-propan-1-one, benzophenone, methyl o-benzoylbenzoate, ethyl-4-dimethyl aminobezoate (EDMAB), 2-isopropylthioxanthon, 2-benzyl-2-dimethylamino-1-morpholinophenyl)-butanone, dimethyl-1,2-diphenyllehan-1-one, benzophenone, 4-benzoyl-4′-methyl diphenylsulfide, camphorquinone, 2-hydroxy-1-{4-[4-(2-hydroxy-2-methylpropionyl) benzyl]phenyl}-2-methyl-propan-1-on (Irgacure 127), 1-hydroxy-cyclohexyl phenyl ketone (Irgacure 184), 1-[4-(2-hydroxyethoxy)phenyl]-2-hydroxy-2-methyl-1-propan-1-on (Irgacure 2959), 2-benzyl-2-dimethylamino-1-(4-morpholino phenyl)-butanone-1 (Irgacure 369), Irgacure 379, 2-(dimethylamino)-2-[(4-methyl phenyl)methyl]-1-[4-(morpholinyl) phenyl]-1-butanone (Irgacure 379EG), 2-methyl-1-(4-methylthiophenyl)-2-morpholino propan-1-on (Irgacure 907), Irgacure 1700, Irgacure 1800, Irgacure 1850, Irgagure 1870, bis(2,4,6-trimethylbenzoyl)phenyl phosphine oxide (Irgacure 819), bis(eta5-2,4-cyclopentadiene-1-yl)phenyl titanium (Irgacure 784), Irgacure 4265, Irgacure PAG 103, Irgacure PAG 121, Irgacure PAG 203, Irgacure CGI 725, Irgacure 250, Irgacure PAG 290 and Irgacure SGID26-1.

In some embodiments, the formulations further comprise at least one additive selected from at least one stabilizer, at least one additional initiator (not necessarily a photoinitiator), at least one dispersant, at least one surfactant, at least one coloring material, at least one dye, at least one rheological agent, at least one humidifier, at least one filler, at least one sensitizer and at least one wetting agent.

In some embodiments, the sensitizer is selected to increase the absorption rate of the light of 300 to 900 nm wavelength.

In some embodiments, the at least one dye is selected from fluorescent dyes, UV-absorbing dyes, IR-absorbing dyes, and combinations thereof. The dyes may be for example quinines, triarylmethanes, pyrans, stilbenes, azastilbenes, nitrones, naphthopyrans, spiropyrans, spirooxazines, fulgides, diarylethenes, and azobenzene compounds.

A formulation according to the invention is typically transparent (clear) or semitransparent, minimizing light scattering.

The invention further provides use of formulations of the invention in a printing process for manufacturing a 3D ceramic or glass object. In some embodiments, the formulations are used or engineered to be used in a printing process for manufacturing a 3D ceramic or glass object. In some embodiments, the formulations are used or engineered to be used in a printing process for manufacturing a 3D ceramic or transparent glass object. In further embodiments, formulations according to the invention are used or engineered for use in a printing process for manufacturing a 3D ceramic or ceramic-organic or transparent glass object. The formulations may additionally or alternatively be used in a printing process for manufacturing a 3D object with HDT above 120° C.

The invention further provides a process for forming a 3D ceramic object or a ceramic pattern, the object or pattern being formed from at least one polymerizable ceramic precursor of the general formula A-B, as defined, under conditions permitting formation of the 3D object. In some embodiments, the printing of the object or pattern is carried out at a temperature below 90° C.

Thus, the invention provides a process for forming a 3D ceramic object or a ceramic pattern, the process comprising applying (e.g., by printing) an ink formulation comprising at least one polymerizable ceramic precursor of the general formula A-B, e.g., on a surface region of a substrate or in a printing bath (depending on the specific printing technology utilized), and irradiating the applied formulation (on a surface or in a bath) by a light source, e.g., UV light, to induce polymerization of the at least one polymerizable ceramic precursor, the process being carried out at a temperature below 90° C., to thereby afford a 3D ceramic object or pattern, and optionally further treating the object or pattern as disclosed herein.

In some embodiments, the application of the ink formulation, e.g., by printing, may be carried out at any temperature below 90° C. In some embodiments, the temperature is between 0° C. and 90° C. In some embodiments, the temperature is between 10° C. and 90° C., between 20° C. and 90° C., between 30° C. and 90° C., between 40° C. and 90° C., between 50° C. and 90° C., between 60° C. and 90° C., between 70° C. and 90° C., between 80° C. and 90° C., between 10° C. and 80° C., between 10° C. and 70° C., between 10° C. and 60° C., between 10° C. and 50° C., between 10° C. and 40° C., between 10° C. and 30° C., between 10° C. and 20° C., between 20° C. and 80° C., between 20° C. and 70° C., between 20° C. and 60° C., between 20° C. and 50° C., between 20° C. and 40° C., between 20° C. and 30° C., between 30° C. and 80° C., between 30° C. and 70° C., between 30° C. and 60° C., between 30° C. and 50° C., between 30° C. and 60° C., between 30° C. and 50° C., between 30° C. and 40° C., between 40° C. and 80° C., between 40° C. and 70° C., between 40° C. and 60° C., between 40° C. and 50° C., between 50° C. and 80° C., between 50° C. and 70° C., between 50° C. and 60° C., between 60° C. and 80° C., between 60° C. and 70° C. or between 70° C. and 80° C.

In some embodiments, the temperature is below 10° C.

In some embodiments, the temperature is between 0° C. and 10° C. In some embodiments, the temperature is about 0° C., about 1° C., about 2° C., about 3° C., about 4° C., about 5° C., about 6° C., about 7° C., about 8° C., about 9° C. or about 10° C.

In some embodiments, the temperature is room temperature (24 to 30° C.) or below room temperature.

The 3D printing process utilizing an ink formulation according to the present invention may be performed by a variety of printing methods as known in the art. For example, the object or pattern may be formed by printing during polymerization with a DLP printer, by utilizing localized irradiation, or by inkjet printing, followed by polymerization-induced light irradiation, wherein the printing and polymerization steps are carried out at a temperature generally below 90° C.

The process of the invention may suitably be operable in a continuous “print and expose” mode, according to which a drop or pattern or layer of an ink formulation is first formed on a surface region or on a previous drop, pattern or layer and which is subsequently exposed to light irradiation for polymerization. In providing such a process, an object may be formed faster and polymerization of the materials may be achieved with more efficiency. In some embodiments of the process, all pixels are exposed one at a time immediately following the printing thereof. In other embodiments, a full pattern or layer is first formed and thereafter exposed to light.

Thus, the invention further provides a process for printing a 3D object/pattern on a surface region of a substrate, the process comprising:

a) forming a pattern of an ink formulation on a surface region of a substrate or on a previously printed pattern; the ink formulation comprising at least one polymerizable ceramic precursor of the formula A-B, as defined;

b) affecting polymerization of at least a portion (or completely) of the polymerizable moieties present in the at least one polymerizable ceramic precursors at a temperature below 90° C.;

c) repeating steps (a) and (b) one or more times to obtain a 3D object/pattern; and

d) optionally performing a post-printing process or step including, but not limited to, aging the 3D object/pattern at room temperature, immersing the 3D object/pattern in acid or base or electrolyte solution followed by heating at a temperature above 100° C. to obtain a ceramic or glass object.

In some embodiments, the process further comprises the step of obtaining an ink formulation as disclosed herein.

In some embodiments, step (c) is performed after both steps (a) and (b) are repeated more than 2 times. In other embodiments, step (c) is performed after both steps (a) and (b) are repeated more than 20 times. In further embodiments, step (c) is performed after both steps (a) and (b) are repeated as many times as may be necessary.

The invention further provides a process for printing a 3D object/pattern on a surface region of a substrate, the process comprising:

a) forming a pattern of an ink formulation on a surface region of a substrate or on a previously printed pattern; the ink formulation comprising at least one polymerizable ceramic precursor of the formula A-B, as defined;

b) affecting polymerization of at least a portion (or completely) of the polymerizable moieties present in the at least one polymerizable ceramic precursors at a temperature below 90° C.;

c) repeating steps (a) and (b) and one or more times to obtain a 3D object/pattern; and

d) optionally performing a post printing process including, but not limited to, aging the 3D object/pattern at room temperature, immersing the 3D object/pattern in acid or base or electrolyte solution followed by heating at a temperature above 100° C. to obtain a ceramic or glass object.

In some embodiments, steps (a), (b) and optionally (d) are repeated one or more times to obtain a 3D ceramic object or pattern. In some embodiments, the 3D object or pattern is detached from the substrate surface.

In some embodiments, the process further comprises the step of obtaining an ink formulation as disclosed herein.

In some embodiments, step (c) is performed after both steps (a) and (b) are repeated more than 2 times. In other embodiments, step (c) is performed after both steps (a) and (b) are repeated as may be necessary or desired.

In some embodiments the printing process also involves printing a support material. This material is removed after the final object is obtained.

The process of the invention may be carried out in a liquid bath, by the DLP printing process, in which case a formulation of the invention is placed or held in a vat or a printing bath, optionally upon a movable platform, and a light source, e.g., a laser beam or any other light beam, is directed at the formulation, such that polymerization occurs where the light beam hits the formulation, at a desired depth. Once a layer is completed, the platform may drop a fraction and a subsequent layer is formed by the light beam. Thus, a DLP process or a stereolitographical process according to the invention may comprise:

a) placing an ink formulation comprising at least one polymerizable ceramic precursor of the formula A-B within a printer bath;

b) affecting polymerization of at least a portion of the polymerizable moieties present in the at least one polymerizable ceramic precursor at a temperature below 90° C. by irradiating the formulation in said bath to form a polymeric layer (having a desired size, pattern etc);

c) repeating step (b) one or more times to obtain a 3D object with a predefined, desired or required height and size; and

d) optionally performing a post printing process including, but not limited to, aging the 3D object/pattern at room temperature, immersing the 3D object/pattern in acid or base or electrolyte solution followed by heating at a temperature above 100° C. to obtain a ceramic or glass object.

In some embodiments, the optional step of heating the object/pattern is carried out at a high temperature, typically being above 100° C. in order to endow the object/pattern with characteristics suitable for the object/pattern end-use. This step may be carried under an inert or reactive atmosphere, under air, under nitrogen, under argon or in vacuum. For example, for the purpose of achieving silica structures or silica-metal structure (such as silica-alumina, zirconia, etc.) heat treatment under air may be required so as to remove the organic materials and in some cases to sinter the resulting object. The post treatment process may include, e.g., heating at elevated temperature, and may be tailored such that the resulting object is essentially inorganic (ceramic) or of a hybrid composite (organic-inorganic). In other instances, heating is performed under inert atmosphere, or under an atmosphere that enables formation of materials such as silicon nitride and silicon carbide or zeolites.

In some embodiments, for achieving sintered ceramic structures, the process may involve two burning steps or a single step involving gradual or step-wise increase in the burn temperature. For example, a first thermal step involves treating the object/pattern under air to remove the organic materials. The second thermal step is carried out at much higher temperatures and under an atmosphere of an inert gas (such as nitrogen, argon, helium) or under vacuum to achieve sintering while preventing crystallization of the ceramic structure.

For achieving silica-carbide structures, silica-carbide-nitride structures or silica-carbide-metal (such as zirconia, alumina, titania, etc) structures, heat treatment under nitrogen, argon, helium or vacuum is required, to cause pyrolysis of the organic materials and sintering of the resulting object. In some embodiments, heating may be carried out under pressure.

As stated, the thermal steps or burning steps are typically carried out at a temperature above 100° C. Depending on the materials used and the particular product requirements, the thermal steps may utilize temperatures as high as 1,200° C. Thus, the burning temperatures may be between 100° C. and 1,200° C. In some embodiments, the burning temperature is between 100° C. and 1,200° C., between 100° C. and 1,150° C., between 100° C. and 1,100° C., between 100° C. and 1,050° C., between 100° C. and 1,000° C., between 100° C. and 950° C., between 100° C. and 900° C., between 100° C. and 850° C., between 100° C. and 800° C., between 100° C. and 750° C., between 100° C. and 700° C., between 100° C. and 650° C., between 100° C. and 600° C., between 100° C. and 550° C., between 100° C. and 500° C., between 100° C. and 450° C., between 100° C. and 400° C., between 100° C. and 350° C., between 100° C. and 300° C., between 100° C. and 250° C., between 100° C. and 200° C., between 100° C. and 150° C., between 200° C. and 1,200° C., between 200° C. and 1,150° C., between 200° C. and 1,100° C., between 200° C. and 1,050° C., between 200° C. and 1,000° C., between 200° C. and 950° C., between 200° C. and 900° C., between 200° C. and 850° C., between 200° C. and 800° C., between 200° C. and 750° C., between 200° C. and 700° C., between 200° C. and 750° C., between 200° C. and 600° C., between 200° C. and 550° C., between 200° C. and 500° C., between 200° C. and 450° C., between 200° C. and 400° C., between 200° C. and 350° C., between 200° C. and 300° C., between 200° C. and 250° C., between 300° C. and 1,200° C., between 300° C. and 1,150° C., between 300° C. and 1,100° C., between 300° C. and 1,050° C., between 300° C. and 1,000° C., between 300° C. and 950° C., between 300° C. and 900° C., between 300° C. and 850° C., between 300° C. and 800° C., between 300° C. and 750° C., between 300° C. and 700° C., between 300° C. and 650° C., between 300° C. and 600° C., between 300° C. and 550° C., between 300° C. and 500° C., between 300° C. and 450° C., between 300° C. and 400° C., between 300° C. and 350° C., between 400° C. and 1,200° C., between 400° C. and 1,150° C., between 400° C. and 1,100° C., between 400° C. and 1,050° C., between 400° C. and 1,000° C., between 400° C. and 950° C., between 400° C. and 900° C., between 400° C. and 850° C., between 400° C. and 800° C., between 400° C. and 750° C., between 400° C. and 700° C., between 400° C. and 650° C., between 400° C. and 600° C., between 400° C. and 550° C., between 400° C. and 500° C., between 400° C. and 450° C., between 500° C. and 1,200° C., between 500° C. and 1,150° C., between 500° C. and 1,100° C., between 500° C. and 1,050° C., between 500° C. and 1,000° C., between 500° C. and 950° C., between 500° C. and 900° C., between 500° C. and 850° C., between 500° C. and 800° C., between 500° C. and 750° C., between 500° C. and 700° C., between 500° C. and 650° C., between 500° C. and 600° C., between 500° C. and 550° C., between 600° C. and 1,200° C., between 600° C. and 1,150° C., between 600° C. and 1,100° C., between 600° C. and 1,050° C., between 600° C. and 1,000° C., between 600° C. and 950° C., between 600° C. and 900° C., between 600° C. and 850° C., between 600° C. and 800° C., between 600° C. and 750° C., between 600° C. and 700° C., between 600° C. and 650° C., between 700° C. and 1,200° C., between 700° C. and 1,150° C., between 700° C. and 1,100° C., between 700° C. and 1,050° C., between 700° C. and 1,000° C., between 700° C. and 950° C., between 700° C. and 900° C., between 700° C. and 850° C., between 700° C. and 800° C., between 700° C. and 750° C., between 800° C. and 1,200° C., between 800° C. and 1,150° C., between 800° C. and 1,100° C., between 800° C. and 1,050° C., between 800° C. and 1,000° C., between 800° C. and 950° C., between 800° C. and 900° C., between 800° C. and 850° C., between 900° C. and 1,200° C., between 900° C. and 1,150° C., between 900° C. and 1,100° C., between 900° C. and 1,050° C., between 900° C. and 1,000° C., between 900° C. and 950° C., between 1,000° C. and 1,200° C., between 1,000° C. and 1,150° C., between 1,000° C. and 1,100° C., between 1,000° C. and 1,050° C., between 1,050° C. and 1,200° C., between 1,050° C. and 1,150° C., between 1,050° C. and 1,100° C., between 1,100° C. and 1,200° C., between 1,100° C. and 1,150° C. and between 1,050° C. and 1,200° C.

In some embodiments, the thermal steps or burning steps are typically carried out at a temperature between 100° C. and 800° C.

The burning temperature is selected to be much higher than the printing temperature for obtaining the 3D object/pattern. As stated above, the printing process is carried out at a temperature below 90° C. or between 0° C. and 90° C., while the temperature at which the formed object/pattern is burnt is at least 100° C. However, in some instances, as demonstrated and described, the object may be treated to induce ceramization, hasten or terminate polymerization, or to be dried under a temperature below the burning temperature. Such a temperature may be as low as 60° C. or between 60° C. and 200° C. Thus, processes of the invention may generally involve three different thermal steps: a first step is the printing step, whereby the object is formed at a temperature below 90° C.; a second step is the drying step, whereby the formed object, once removed from the printing console or printing bath, is post-treated, as described, at a temperature above 60° C. and under specified conditions; and a third step is the burning step, whereby the object formed, after having been optionally dried and post-treated, is further thermally treated (burnt) at a temperature above 100° C. to afford the ceramic or glass end product. As noted herein, the second and/or third thermal treatment steps above are optional.

The continuous process of the invention may be performed by several printing methods, such as ink-jet printing, stereolithography and digital light processing (DLP). In some embodiments, the printing is achieved by ink-jet printing. As used herein, the term “ink-jet printing” refers to a nonimpact method for producing a pattern by the deposition of ink droplets in a pixel-by-pixel manner onto the substrate. The ink-jet technology which may be employed in a process according to the invention for depositing ink or any component thereof onto a substrate, according to any one aspect of the invention, may be any ink-jet technology known in the art, including thermal ink-jet printing, piezoelectric ink-jet printing and continuous ink-jet printing.

Depending on a variety of parameters, inter alia, the material to be polymerized, the transparency of the formulation, the complexity of the formulations, different light sources may be used to define different exposure patterns (spectral patterns, namely wavelength and intensity; and time patterns, namely duration of exposure and pulse patterns). In some embodiments, the irradiated light is selected to be of a wavelength between 300 to 900 nm.

In some embodiments, the light source is an ultraviolet (UV) laser source. In some embodiments, the light source is an ultraviolet (UV) LED source. In some embodiments, the light source is an ultraviolet (UV) mercury lamp source.

In some embodiments, the light source is a visible LED source.

In some embodiments, the light source is an IR and NIR source.

In some embodiments, the light source, e.g., UV, is focused to the desired spot, region, area within the liquid bath of the DLP printer or at the surface of the printed ink drop in case of inkjet printer, at intensities and radiation durations which are suitable to enable fixation and polymerization of the pattern or object.

The 3D printing process of the invention comprises any one or more manufacturing techniques, steps and processes known for sequential delivery of materials and/or energy to specified spots, regions or areas on a surface region to produce the 3D object. As such, the 3D printing process typically involves providing a 3D printer with machine instructions that define not only information relating to the size and shape of the object, but also to its internal structure. For the purpose of the invention, the process comprises stereo-lithography steps which permit both defining the outer perimeter of the object as well as the inner structure.

In case of printing on a substrate, the substrate, on top of which a printed pattern is formed, may be any substrate which is stable and remains undamaged under the curing and sintering conditions employed by the process of the present invention. In most general terms, the substrate may be of a solid material such as metal, glass, paper, an inorganic or organic semiconductor material, a polymeric material or a ceramic surface. The surface material, being the top-most material of the substrate on which the film is formed, may not necessarily be of the same material as the bulk of the substrate. In some embodiments, the substrate is selected amongst such having been coated with a film, coat or layer of a different material, said different material constituting the surface material of a substrate on which a pattern in formed. In other embodiments, the substrate may have a surface of a material which is the same as the printed material.

In some embodiments, the surface onto which the pattern is formed is selected from the group consisting of glass, silicon, metal, ceramic and plastic.

According to some embodiments of the invention, the pattern may be formed onto a surface region of a substrate by any method, including any one printing method, as described herein.

In some embodiments, the surface may be selected to be detachable from the pattern or structure.

In some embodiments, the printing processes comprises a step of forming, by printing, a surface or a support onto which an object according to the invention may be formed.

Objects obtained by any of the processes of the invention may further undergo post printing processes, in which the ceramic or hybrid ceramic-organic material is formed after fixation of the initial object, and the organic residues are removed partially or completely, as disclosed herein. The post treatment may involve dipping the object/pattern in an acid or base or electrolytes or dispersion of particles or any other material and heating to elevated temperatures, as defined.

Object and patterns of the invention are characterized by improved mechanical and heat resistant properties.

### BRIEF DESCRIPTION OF THE DRAWINGS

In order to better understand the subject matter that is disclosed herein and to exemplify how it may be carried out in practice, embodiments will now be described, by way of non-limiting example only, with reference to the accompanying drawings, in which:

FIG. 1 shows a printed structure according to the invention: plate (1) shows the structure before heat treatment; plate (2) shows the structure after heating at 300° C.; and plate (3) shows the structure after heating at 700° C.

FIG. 2 summarizes TGA measurements of samples composed of 87.3 wt % AcryloPOSS, 9.7 wt % APTMS and 3 wt % TPO. The measurements were carried out on a heated sample (1); under N₂ (2); under air and on a sample composed of organic polymer SR9035 heated under N₂ (3).

FIG. 3 shows images of 3D printed structures burnt under air at different temperatures, as indicated. The structures was printed from: line 1-ethoxy-TMPTA ink formulation, and line 2-1:1 POSS:APTMS ink formulation according to the invention. See detail description.

FIG. 4 presents images of 3D printed structures heated under nitrogen to different temperatures, as indicated. The structures were printed from: line 1-ethoxy-TMPTA ink formulation, and line 2-1:1 POSS:APTMS ink formulation according to the invention. See disclosure.

FIG. 5 presents an image of 3D printed structures composed of formulation 5.

FIG. 6 shows the results of TGA measurements of structures composed of 92.15 wt % APTMS, 4.85 wt % ethoxy(15)TMPTA and 3 wt % TPO burn under nitrogen. (1) After immersion in HCl; (2) without immersion in HCl and compared to (3) commonly used organic monomer ethoxy-TMPTA (without the hybrid monomer).

FIG. 7 demonstrates the printing ability of a formulation of the invention and the thermal stability of printed structures: (1) immediately after printing, (2) after post treatment of 48 hours in citric acid, and (3) post treatment of 48 hours in AMP solution. The photos in the lower row are of the same structures but after heating at 150° C. for 1 h and then at 190° C. for 1 h.

FIG. 8 demonstrates the printing ability and thermal stability of printed structures: (1) immediately after printing, (2) after post treatment for 48 hours in citric acid, (3) and post treatment for 48 hours in AMP solution. The photos in the lower row are of the same structures but after heating at 150° C. for 1 h and then at 190° C. for 1 h.

FIG. 9 provides images of a printed structure made of formulation 10: (1) after printing, (2) after heating at 150° C. for 1 h and then at 190° C. for 1 h.

FIG. 10 provides images of a printed structure made of formulation 11: (1) after printing, (2) after heating at 150° C. for 1 h and then at 190° C. for 1 h.

FIGS. 11A-C provide images of 3D structures made of formulation 13 with 0.5 wt % (left star in each picture), 1 wt % (middle star in each picture) and 5 wt % (right star in each picture) of titanium isopropoxide: (FIG. 11A) after curing, (FIG. 11B) 500° C. under air; (FIG. 11C) after 1,150° C. under vacuum.

FIG. 12 provides images of a printed formulation 15, after a thermal treatment at 800° C.

FIG. 13 presents a TGA measurement of a printed structure formed of formulation 15. It can be seen that the weight loss was about 30 wt % after 600° C.

FIG. 14 present transparent 3D silica glass structure from formulation 16: (left) after printing (middle) after drying at 60° C. (right) after heating to 800° C.

FIG. 15 shows the TGA measurement of formulation 19 after printing. Heating rate of 1° C./min from 25° C. to 1,000° C.

FIG. 16 shows images of printed structures made of formulation 20: (left structure) after printing, (right structure) SiOC structure after 2 h at 1,150° C. under vacuum.

FIG. 17 provides an image of a printed structure made of formulation 22 after printing.

### DETAILED DESCRIPTION OF EMBODIMENTS

### Example 1: Method for Making Printable Ceramic Silica Structure

An ink formulation is prepared by mixing 87.3 wt % Acrylo POSS (Hybrid plastics, USA), 9.7 wt % APTMS (Gelest, USA) and 3 wt % 2,4,6-trimethyldiphenyl phosphineoxide, TPO (BASF, Germany) as photoinitiator. After mixing for a few minutes in a hot water bath the mixture was poured into the monomer bath of the DLP 3D printer Freeform 39 plus (Asiga, Australia). The printing was done by curing 50 μm layer-by-layer for 5 sec. The structure then was immersed in iso-propyl alcohol (IPA) in an ultrasonic bath for 1 min to remove residues of the uncured monomer.

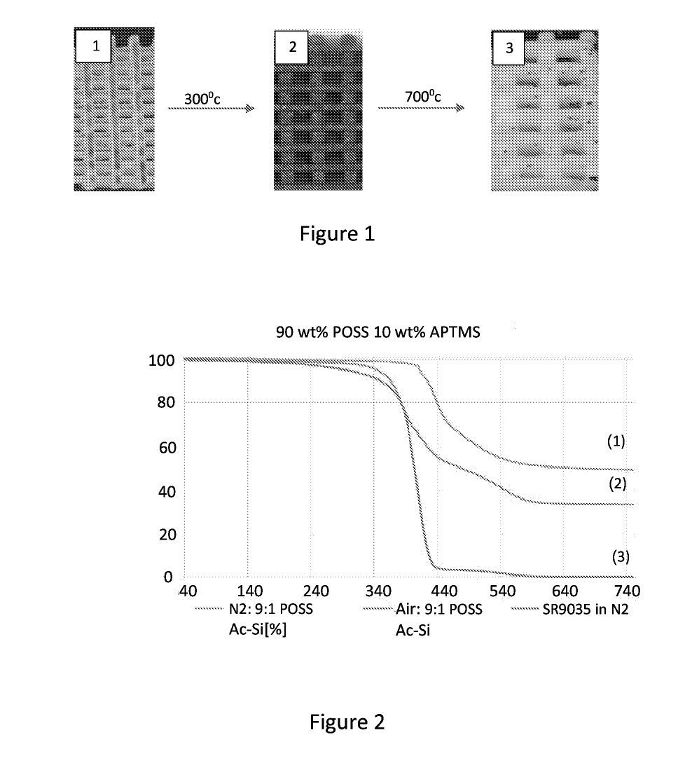

To demonstrate the thermal durability, the structure was heated first to 300° C. at 2° C./min, than to 500° C. at 7° C./min, than to 700° C. at 1° C./min under air. As may be observed from FIG. 1, the structure retained its form after heating to 700° C., even though it lost 42 wt %, see FIG. 2.

TGA measurements were conducted under air and nitrogen on a cured droplet (FIG. 2). For comparison the mixture was also compared to common to used monomer ethoxylated (15) TMPTA (SR9035, Sartomer) mixed with 0.5 wt % TPO.

### Example 2: Method for Making Printable Ceramic—Silica Structure

An ink formulation was prepared by mixing 48.5 wt % Acrylo POSS (Hybrid plastics, USA), 48.5 wt % APTMS (Gelest, USA) and 3 wt % 2,4,6-trimethyldiphenyl phosphineoxide, TPO (BASF, Germany) as a photoinitiator. After mixing for a few minutes in a hot water bath the mixture was poured into the monomer bath of the DLP 3D printer Freeform 39 plus (Asiga, Australia). The printing was done by curing 50 μm layer-by-layer for 4 sec. The structure then was immersed in iso propyl alcohol (IPA) in an ultrasonic bath for 1 min to remove residues of the uncured monomer.

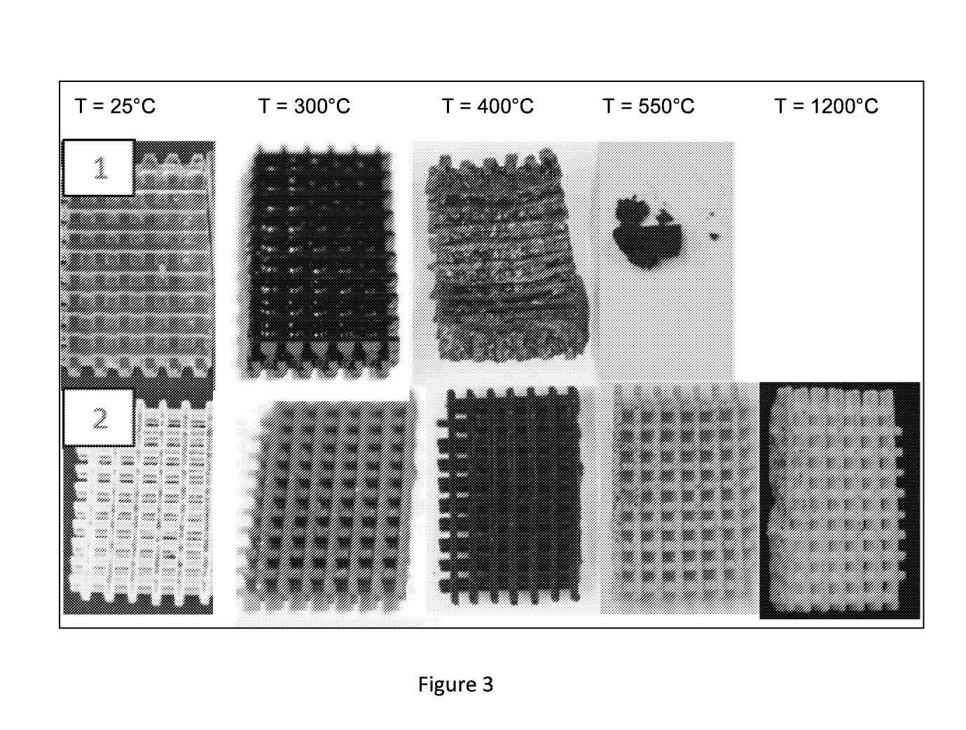

To achieve silica structure, the structure was burnt under air at 1200° C. To remove all carbon residues, the structure was heated under air, first to 300° C. at 2° C./min for 1.5 h, than to 400° C. at 2° C./min for 1.5 h, than to 550° C. at 2° C./min for 1.5 h, than to 1200° C. at 5° C./min for 1 h. As FIG. 3 shows, a comparison of the discussed printed ink formulation to a similar 3D structure made of a commonly used monomer, ethoxylated (15) trimethylolpropane triacrylate (Ethoxy-TMPTA, SR9035, Sartomer) mixed with 0.5 wt % TPO, indicates that at 550° C. the organic structure almost completely disappeared, while the hybrid structure still remained in its original form. After further burning to 1200° C., the structure became white, suggesting complete removal of the organic parts in this hybrid structure, and formation of a ceramic structure.

### Example 3: A Method for Making Printable Ceramic Silica-Oxycarbide Structure

An ink formulation is prepared by mixing 48.5 wt % Acrylo POSS (Hybrid plastics, USA), 48.5 wt % APTMS (Gelest, USA) and 3 wt % 2,4,6-trimethyldiphenyl phosphineoxide, TPO (BASF, Germany) as photo initiator. After mixing for a few minutes in a hot water bath the mixture was poured into the bath of the DLP 3D printer Freeform 39 plus (Asiga, Australia). The printing was done by curing 50 μm layer by layer for 4 sec. The structure was then immersed in iso propyl alcohol (IPA) in ultrasonic bath for 1 min to remove the uncured monomer residue.

To achieve silica-carbide structure the structure was heated under nitrogen to 1,000° C.

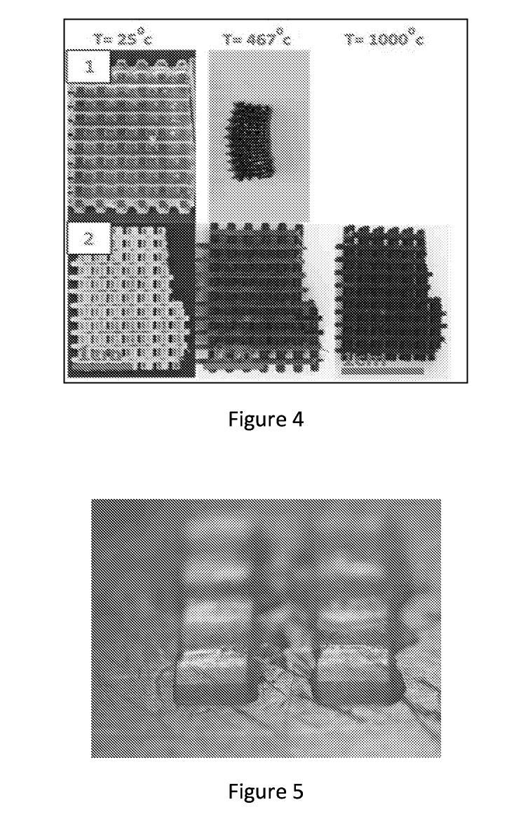

The heat profile was preform under nitrogen, first increasing to 467° C. at 2° C./min for 1.5 h than to 1,000° C. at 5° C./min for 1 h. FIG. 4 shows a comparison of the discussed printed ink formulation to a similar 3D structure made of common used monomer ethoxylated (15) Trimethylolpropane triacrylate (Ethoxy-TMPTA, SR9035, Sartomer) mixed with 0.5 wt % TPO. It can be seen from FIG. 4 that the hybrid structure remained in its original form while the organic structure lost its form completely. This attests to the formation of a ceramic structure. Furthermore, the black color of the structure, after heating, indicates a trapped carbon within the silica matrix, meaning a formation of silica-carbide within structure.

### Example 4: A Method for Making a Printable Ceramic Silica-Oxycarbide Structure

An ink formulation is prepared by mixing 49.5 wt % APTMS (Gelest, USA), 24.75 wt % Ebecryl 113, 24.75 wt % Ebecryl 8411 (Allnex, Belgium) and wt % 2,4,6-trimethyldiphenyl phosphineoxide, TPO (BASF, Germany) as photo initiator. The formulation was cured in a mold for 20 sec.

To achieve silica-carbide structure the structure was heated under nitrogen to 800° C.

The heat profile was preform under nitrogen, for 800° C. at 10° C./min for 3 h. XPS measurements shows that the object contains silica and silicon carbide.

### Example 5: Method for Making a Printable Hybrid Ceramic Organic-Silica-Silazane Structure

An ink formulation was prepared by mixing 99-X wt % Acrylo POSS (Hybrid plastics, USA), X wt % silazane (KDT HTA 1500 Rapid and Slow, wherein X=80 wt % and 90 wt %) and 1 wt % 2,4,6-trimethyldiphenyl phosphineoxide, TPO (BASF, Germany) as a photoinitiator. After mixing for a few minutes in a hot water bath the mixture was poured into the bath of the DLP 3D printer Pico2 (Asiga, Australia). The printing was done by curing 25 μm layer by layer for 1.2 sec each layer. FIG. 5 shows a printed cubes structures.

For achieving better mechanical strength, the structure was kept in an open vessel in an oven at 60° C. for several days.

### Example 6: Method for Making Printable Ceramic Silicon Oxynitride Structure

An ink formulation was prepared by mixing 99-X wt % Acrylo POSS (Hybrid plastics, USA), X wt % silazane (KDT HTA 1500 Rapid and Slow, wherein X=49 wt %, 65 wt %, 85 wt %, 90 wt % and 95 wt %) and 1 wt % 2,4,6-trimethyldiphenyl phosphineoxide, TPO (BASF, Germany) as a photoinitiator. After mixing for a few minutes in a hot water bath the mixture cured in a mold.

For achieving silica-nitride, post treatment was performed by heating the printed structures to 800° C. under nitrogen atmosphere for 3 hours at heating rate of 10° C./min XPS measurements shows that the object contains silica and silicon nitride.

### Example 7: Method for Making Printable Hybrid Ceramic Structure

An ink formulation is prepared by mixing 92.15 wt % APTMS (Gelest, USA), 4.85 wt % ethoxy(15)TMPTA (SR9035, Sartomer) and 3 wt % 2,4,6-trimethyldiphenyl phosphineoxide, TPO (BASF, Germany) as photo initiator. After mixing for a few minutes the mixture was purred into the monomer bath of the DLP 3D printer Freeform 39 plus (Asiga, Australia). The printing was done by curing 100 μm layer by layer for 5 sec. For achieving thermal durability there is a need for post process of immersing the printed structure into HCl solution with pH 2.5 for 4 days for achieving hydration and condensation for the formation of siloxane bond within the organic matrix. Another post printing process was immersing the printed structure in citric acid solution with pH 4 for 48 hours or in 0.05% AMP solution with pH 10 for 48 hours.

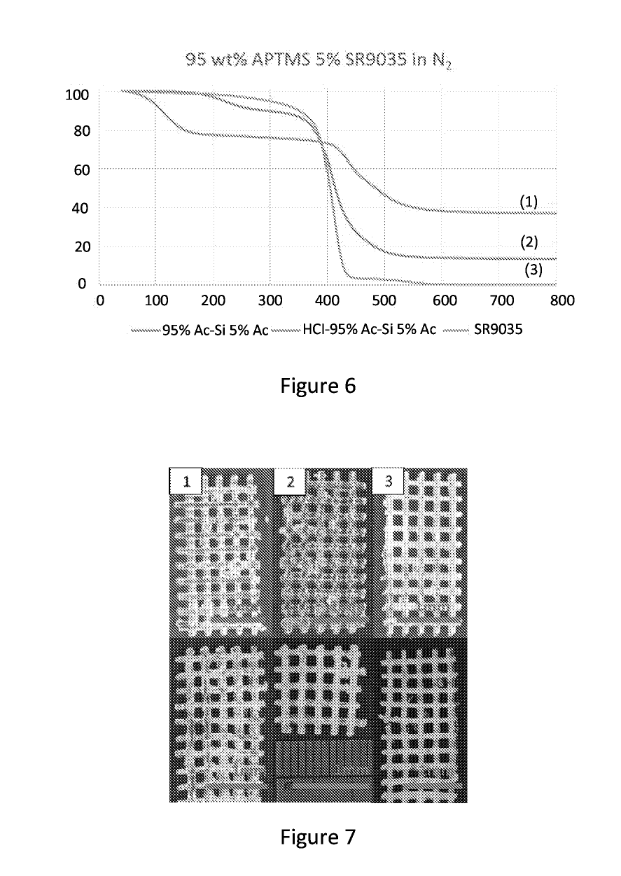

TGA measurement were conducted under nitrogen on cured photocured samples. The graphs shows comparison between droplet immersed in HCl solution with pH 2.5 for 4 days and droplet that have not been immersed in HCl. The mixture is also compared to common used monomer ethoxylated (15) TMPTA (SR9035, Sartomer) mixed with 0.5 wt % TPO (FIG. 6).

The image provided in FIG. 7 demonstrates the printing ability of the formulation and the thermal stability of the printed structures, (1) immediately after printing, (2) after post treatment for 48 hours in citric acid, and (3) post treatment for 48 hours in AMP solution. The images in the lower row are the same structures but after heating at 150° C. for 1 h and then at 190° C. for 1 h.

### Example 8: Method for Making Printable Ceramic Silica Structure/Object

An ink formulation was prepared by mixing 87.3 wt % APTMS (Gelest, USA), 9.7 wt % ethoxy(15)TMPTA (SR9035, Sartomer) and 3 wt % 2,4,6-trimethyldiphenyl phosphineoxide, TPO (BASF, Germany) as a photoinitiator. After mixing for a few minutes the mixture was purred into the monomer bath of the DLP 3D printer Freeform 39 plus (Asiga, Australia). The printing was done by curing 100 μm layer by layer for 10 sec. A post process was performed by immersing the printed structures into citric acid solution with pH 4 for 48 hours or in 0.05% AMP solution with pH 10 for 48 hours

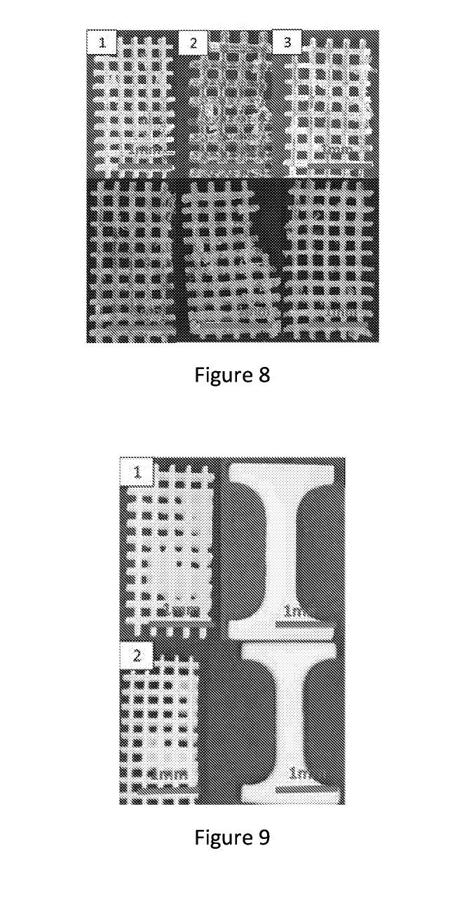

FIG. 8 demonstrates the printing ability and the thermal stability of the printed structures, (1) immediately after printing, (2) after post treatment for 48 hours in citric acid, and (3) post treatment for 48 hours in AMP solution. The images in the lower row are the same structures but after heating at 150° C. for 1 h and then at 190° C. for 1 h.

### Example 9: Method for Making a Printable Object

An ink formulation is prepared by mixing 87.6 wt % APTMS (Gelest, USA), 9.9 wt % ebecryl 113, 1.485% ebecryl 8411 (Allnex, Belgium) and 1 wt % 2,4,6-trimethyldiphenylphosphineoxide, TPO (BASF, Germany) as photo initiator. After mixing for a few minutes the mixture was purred into the monomer bath of the DLP 3D printer Freeform 39 plus (Asiga, Australia). The printing was done by curing 100 μm layer by layer for 10 sec. A post process was performed by immersing the printed structure into citric acid solution with pH 4 for or with 0.05% AMP solution with pH 10.

### Example 10: Method for Making Printable Ceramic Silica 3D Object

An ink formulation was prepared by mixing 14.85 wt % Vinyl POSS (Hybrid plastics, USA), 75.735 wt % Ebecryl 113, 8.415% Ebecryl 8411 (Allnex, Belgium) and 1 wt % 2,4,6-trimethyldiphenylphosphineoxide, TPO (BASF, Germany) as a photoinitiator. After mixing for 20 minutes in a hot water bath, the mixture was poured into the monomer bath of the DLP 3D printer Freeform 39 plus (Asiga, Australia). The printing was done by curing 100 μm layer by layer for 5 sec.

Good structures were obtained (FIG. 9) both after printing and after heating at 150° C. for 1 h and then at 190° C. for 1 h.

### Example 11: Method for Making Printable Ceramic Silica Structure

An ink formulation was prepared by mixing 14.85 wt % octasilane POSS (Hybrid plastics, USA), 75.735 wt % ebecryl 113, 8.415% ebecryl 8411 (Allnex, Belgium) and 1 wt % 2,4,6-trimethyldiphenylphosphineoxide, TPO (BASF, Germany) as a photoinitiator. After mixing for 20 minutes in a hot water bath the mixture was purred into the monomer bath of the DLP 3D printer Freeform 39 plus (Asiga, Australia). The printing was done by curing 100 μm layer by layer for 5 sec.

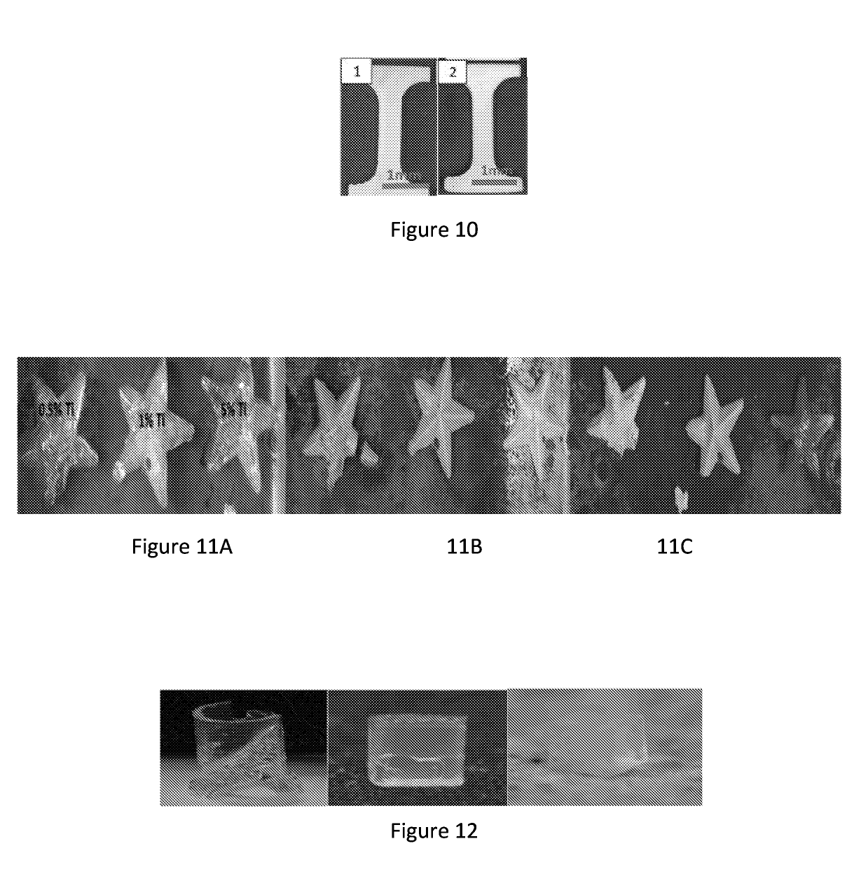

Good structures were obtained (FIG. 10) both after printing and after heating at 150° C. for 1 h and then at 190° C. for 1 h.

### Example 12: Method for Making Printable Hybrid Ceramic Silica Structure

An ink formulation was prepared by mixing 19.8 wt % acrylo POSS (Hybrid plastics, USA), 79.2 wt % PEG600 diacrylate (SR610, Sartomer) and 1 wt % 2,4,6-trimethyldiphenylphosphineoxide, TPO (BASF, Germany) as a photoinitiator. After mixing for 20 minutes in a hot water bath the mixture was poured into the monomer bath of the DLP 3D printer Freeform 39 plus (Asiga, Australia). The printing was done by curing 100 μm layer by layer for 2 sec.

This formulation also enabled printing of structures which were stable after heating at 150° C. for 1 h and then at 190° C. for 1 h.

### Example 13: Method for Making Printable Ceramic Titania-Silica 3D Structure

An ink formulation is prepared by mixing (97-X) wt % Acrylo POSS (Hybrid plastics, USA), X wt % (X=0.5, 1 and 5) titanium isopropoxide (Sigma Aldrich) and 3 wt % 2,4,6-trimethyldiphenylphosphineoxide, TPO (BASF, Germany) as photo initiator. After mixing for a few minutes in a hot water bath the mixture was poured into a mold and was cured for a few seconds.

For achieving silica-titania structure, the cured structure was heated at low rate under air to 500° C. for 1 h and then heated to 1150° C. under vacuum. The resulting 3D ceramic objects are shown in FIG. 11. As it can be seen from FIG. 11 larger concentration of titania resolve in darker 3D structure.

### Example 14: Method for Making Printable Ceramic Titania-Silicon Oxycarbide 3D Structure

An ink formulation is prepared by mixing (97-X) wt % Acrylo POSS (Hybrid plastics, USA), X wt % (X=0.5, 1 and 5) titanium isopropoxide (Sigma Aldrich) and 3 wt % 2,4,6-trimethyldiphenylphosphineoxide, TPO (BASF, Germany) as photo initiator. After mixing for a few minutes in a hot water bath the mixture was poured into a mold and was cured for a few seconds.

For achieving silica-carbide-titania structure, the cured structure should be heated at low rate under nitrogen or vacuum to 800° C. or higher.

### Example 15: A Method for Making a Printable 3D Transparent Silica Glass Structure

An ink formulation was prepared by forming a siloxane oligomer with acrylic groups by the sol gel technique. First by hydrolyzing TEOS mixed with hybrid alkoxide-acrylic monomer for 1 h, followed by condensation.

20 grams of ink formulation is prepared by mixing 8.54 gr of tetraethyl orthosilicate (TEOS, Acros) with 3 gr of acidic 65 wt % ethanol in water solution (0.3 wt % of HNO₃ in ethanol solution) for 30 min. After 30 min 2.14 gr of APTMS and 0.053 gr of TPO was added to the solution for addition of 60 min mixing. Then 6.34 gr of basic 65 wt % ethanol in water solution (1.5 wt % of ammonium acetate (sigma Aldrich) in ethanol solution) was added for condensation and mixed for addition 50 min. This formulation was printed by DLP 3D printer asiga 2 (Asiga, Australia). After printing, the 3D object was kept in a sealed vessel at 60° C. for 24 h for further gelation, then kept in an open vessel at 60° C. for 48 h for removal of solvents. The organic residue was remove by heating to 800° C. for 1 h, at a heating rate of 0.6° C./min. It may be noted from FIG. 12 that the printed structures after treatment at 800° C. remained transparent.

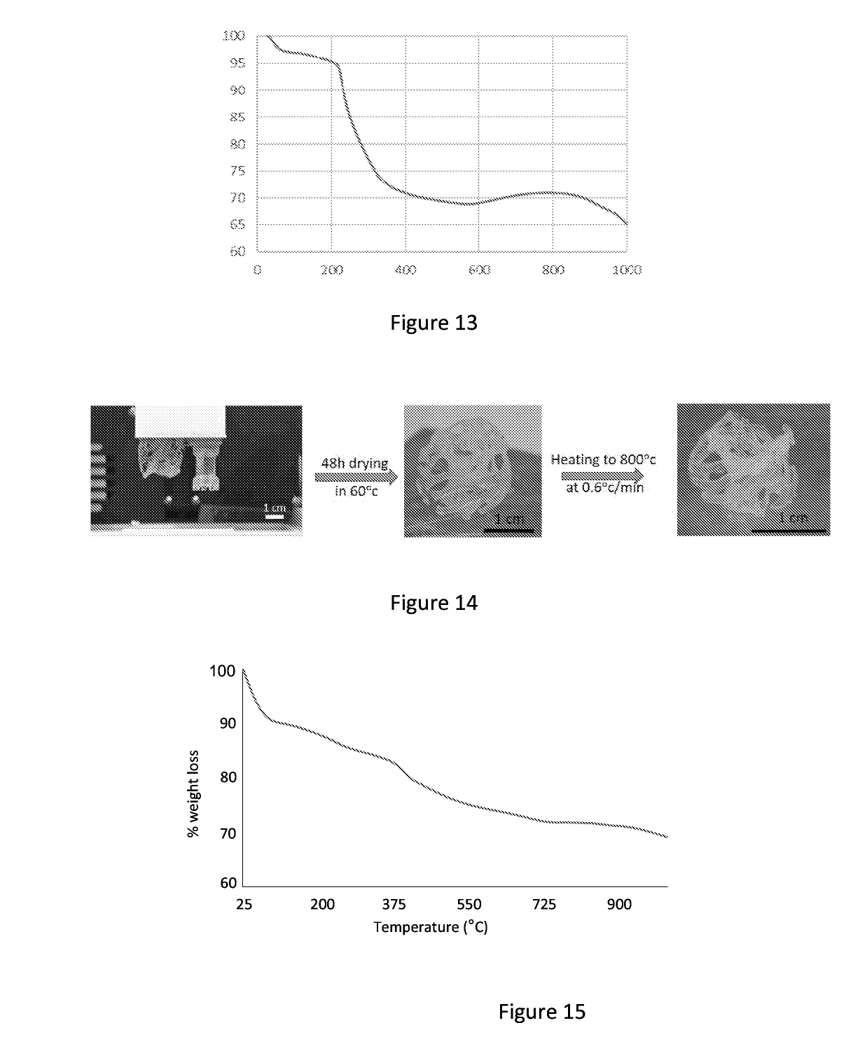

FIG. 13 presents TGA measurements of a printed structure made from formulation 15, it can be seen that the weight loss was about 30 wt % after 600° C.

### Example 16: A Method for Making a Printable 3D Transparent Silica Glass

An ink formulation was prepared by forming a siloxane oligomer with acrylic groups by the sol gel technique. First by hydrolyzing TEOS mixed with hybrid alkoxide-acrylic monomer for 1 h, followed by condensation.

20 grams of ink formulation is prepared by mixing in iced-water bath 8.01 gr of tetraethyl orthosilicate (TEOS, Acros) with 3 gr of acidic 65 wt % ethanol in water solution (0.3 wt % of HNO₃ in ethanol solution) for 30 min. After 30 min 2.67 gr of APTMS and 0.053 gr of TPO was added to the solution for addition of 60 min mixing. Then 6.34 gr of basic 65 wt % ethanol in water solution (1.5 wt % of ammonium acetate (sigma Aldrich) in ethanol solution) was added for condensation and mixed for addition 20 min. This formulation was printed by DLP 3D printer asiga 2 (Asiga, Australia) After printing, the 3D object was kept in a sealed vessel at 60° C. for 24 h for further gelation, then kept in an open vessel at 60° C. for 48 h for removal of solvents. The organic residue was remove by heating to 800° C. for 1 h, at a heating rate of 0.6° C./min.

FIG. 14 present a printed 3D structure after printing, after drying at 60° C. and after heating to 800° C.

### Example 17: A Method for Making Printable 3D Silica Aerogel Structure

20 grams of an ink formulation was prepared by mixing 8.54 gr of tetraethyl orthosilicate (TEOS, Acros) with 3 gr of acidic 65 wt % ethanol in water solution (0.3 wt % of HNO₃ in ethanol solution) for 30 min. After 30 min 2.14 gr of APTMS and 0.053 gr of TPO was added to the solution for addition of 60 min mixing. Then 6.34 gr of basic 65 wt % ethanol in water solution (1.5 wt % of ammonium acetate (sigma Aldrich) in ethanol solution) is added for condensation and mixed for addition 50 min

The formulation was printed by DLP 3D printer asiga 2 (Asiga, Australia). After printing, the silica structure was kept in a sealed vessel at 60° C. for 24 h, than the structure was immersed in acetone for 1 week at 40° C., replacing the acetone every day. After a week, the acetone was replaced with CO₂ by supercritical drying, for 4 days. The resulting structure withstood 800° C. without cracking or shrinking, and it is composed of silica aerogel. The structure did not shrink after heating to 800° C. and were semi-transparent with light bluish color, typical to aerogels.

### Example 18: A Method for Making Printable Silica Structure

20 grams of ink formulation was prepared by mixing 4.27 gr of tetraethyl orthosilicate (TEOS, Acros) with 3 gr of acidic 65 wt % ethanol in water solution (0.3 wt % of HNO₃ (Sigma Aldrich) in ethanol solution) for 30 min After 30 min 4.27 gr of polydiethoxysilane (Gelest, USA), 2.14 gr of APTMS and 0.053 gr of TPO was added to the solution for addition of 60 min mixing. Then 6.34 gr of basic 65 wt % ethanol in water solution (1.5 wt % of ammonium acetate (sigma Aldrich) in ethanol solution) was added for condensation and mixed for addition 50 min. This formulation is 3D printed by DLP 3D printer asiga 2 (Asiga, Australia).

After printing, the 3D structure was kept in a sealed vessel at 60° C. for 24 h for further gelation, then in open vessel at 60° C. for 48 h for removal of solvents. The organic residue was removed by heating to 800° C. for 1 h in heating rate of 0.6° C./min.

### Example 19: A Method for Making Printable 3D Silica Structure

An ink formulation was prepared by forming a siloxane oligomer with acrylic groups by the sol gel technique. First by hydrolyzing TMOS, MTMS and hybrid alkoxide-acrylic monomer which were put together, for 30 min, followed by condensation via evaporation of the by-products—alcohol and water, for 200 min, promoting the formation of the siloxsanes bonds.

The formulation was prepared by mixing 12.45 wt % of tetramethyl orthosilicate (TMOS, sigma Aldrich), 62.3 wt % of MTMS (methyltrimetoxysilane, 97%, Acros), 8.3 wt % of APTMS and 1 wt % of TPO with 16 wt % of acidic water (0.5 mM of HCl (Sigma Aldrich) in water) for 30 min in 50° C. in a closed and dark vessel. After 30 min the temperature was increased to 70° C. and the vessel was opened while the formulation continued to be stirred for additional 200 min.

The formulation was poured into a 3D DLP printer monomer bath and is ready for printing in a resolution up to 500 μm at the Z-axis.

Printing of the formulation results in transparent 3D structure with high silica content the 3D object was kept in a sealed vessel at 60° C. for 24 h, then in an open vessel at 60° C. for 48 h, the organic residues are removed by heating to 800° C. for 2 h at a heating rate of 0.6° C./min (as can be seen from FIG. 15, the structure remained with 70 wt % of the starting weight). The resulting 3D structure was composed of amorphous silica (confirmed by XRD).

### Example 20: A Method for Making Printable 3D SiOC Structure

An ink formulation was prepared by forming a siloxane oligomer with acrylic groups by the sol gel process. First by hydrolyzing mixture of TMOS, MTMS and hybrid alkoxide-acrylic monomer for 30 min, followed by condensation via evaporation of the by-products—alcohol and water, for 200 min, promoting the formation of the siloxsanes bonds.

The formulation was made by mixing 12.45 wt % of Tetramethyl orthosilicate (TMOS, sigma Aldrich), 62.3 wt % of MTMS (methyltrimetoxysilane, 97%, Acros), 8.3 wt % of APTMS and 1 wt % of TPO with 16 wt % of acidic water (0.5 mM of HCl (Sigma Aldrich) in water) for 30 min in 50° C. in close and dark vessel. After 30 min the temperature was increased to 70° C. and the vessel was opened while the formulation continued to be stirred for additional 200 min.

The formulation was poured into a 3D DLP printer monomer bath and is ready for printing in a resolution up to 500 μm at the Z-axis.

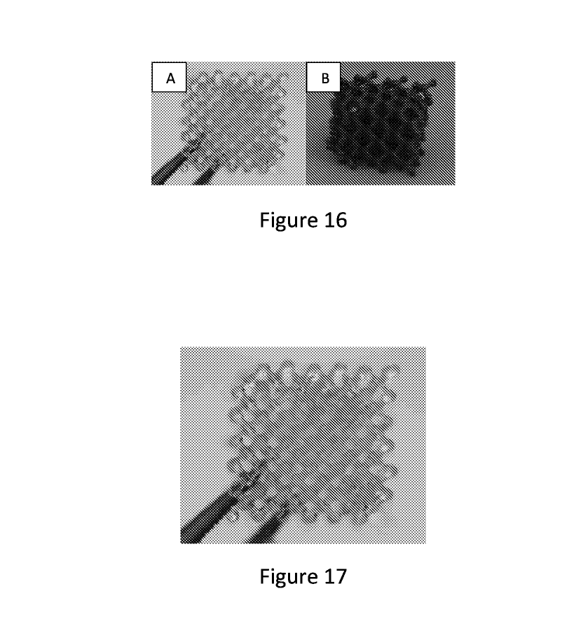

Printing of the formulation resulted in a transparent 3D structure with high silica content (FIG. 16 left), the 3D object is kept in a sealed vessel at 60° C. for 24 h, then in an open vessel at 60° C. for 48 h. The organic residues were removed by heating to 1,150° C. for 2 h under a vacuum at a heating rate of 1° C./min. The resulting 3D structure shown in FIG. 16 (right picture) is composed of SiOC.

### Example 21: A Method for Making Printable 3D Hybrid Aerogel Structure

An ink formulation was prepared by forming a siloxane oligomer with acrylic groups by the sol gel technique. First by hydrolyzing a mixture of TMOS, MTMS and hybrid alkoxide-acrylic monomer for 30 min, followed by condensation via evaporation of the by-product—alcohol and water for 90 min, thus promoting the formation of the siloxsanes bonds.

The formulation was made by mixing 10.67 wt % of Tetramethyl orthosilicate (TMOS, sigma Aldrich), 53.46 wt % of MTMS (methyltrimetoxysilane, 97%, Acros), 7.17 wt % of APTMS and 0.85 wt % of TPO with 8.88 wt % of acidic water (0.5 mM of HCl (Sigma Aldrich) in water) and 4.8 wt % of Ethanol for 30 min in 50° C. in closed and dark vessel. After 30 min 4.8 wt % ethanol, 8.88 wt % water and 0.5 wt % of ammonium acetate (sigma Aldrich) was added, the vessel was opened and the temperature was increased to 70° C. The formulation continue to be stirred for additional 90 min.

The formulation was poured into a 3D DLP printer monomer bath and was ready for printing at a resolution up to 500 μm at the Z-axis.

After printing, the transparent hybrid silica 3D structure was kept in a sealed vessel at 60° C. for 24 h, then the structure is immersed in acetone for 1 week at room temperature while replacing the acetone every day. After a week the acetone was replaced with CO₂ by a supercritical drying process for 4 days, resulting in a 3D hybrid aerogel object.

### Example 22: A Method for Making Printable Transparent Hybrid High Silica Content 3D Structure

An ink formulation was prepared by forming a siloxane oligomer with acrylic groups by the sol gel technique. First by hydrolyzing TMOS, MTMS and hybrid alkoxide-acrylic monomer which were put together, for 30 min, followed by condensation via evaporation of the by-products—alcohol and water, for 200 min, promoting the formation of the siloxanes bonds.

The formulation was prepared by mixing 12.45 wt % of tetramethyl orthosilicate (TMOS, sigma Aldrich), 62.3 wt % of MTMS (methyltrimetoxysilane, 97%, Acros), 8.3 wt % of APTMS and 1 wt % of TPO with 16 wt % of acidic water (0.5 mM of HCl (Sigma Aldrich) in water) for 30 min in 50° C. in a closed and dark vessel. After 30 min the temperature was increased to 70° C. and the vessel was opened while the formulation continued to be stirred for additional 200 min.

The formulation was poured into a 3D DLP printer monomer bath and is ready for printing in a resolution up to 500 μm at the Z-axis.

Printing of the formulation resulted in a transparent 3D structure with high silica content. The 3D object was kept in a sealed vessel at 60° C. for 24 h, then in an open vessel at 60° C. for a minimum of 48 h. The resulted transparent high content silica structure is shown in FIG. 17.

### Example 23: A Method for Making a Printable 3D Silica Glass Structure at a Low Temperature

An ink formulation was prepared by forming a siloxane oligomer with acrylic groups by the sol gel technique. First by hydrolyzing TEOS mixed with hybrid alkoxide-acrylic monomer for 1 h, followed by condensation.

20 grams of ink formulation is prepared by mixing in iced-water bath 8.54 gr of tetraethyl orthosilicate (TEOS, Acros) with 3 gr of acidic 65 wt % ethanol in water solution (0.3 wt % of HNO₃ in ethanol solution) for 30 min. After 30 min 2.14 gr of APTMS and 0.053 gr of TPO was added to the solution for addition of 60 min mixing. Then 6.34 gr of basic 65 wt % ethanol in water solution (1.5 wt % of ammonium acetate (sigma Aldrich) in ethanol solution) was added for condensation and mixed for addition 50 min. This formulation was printed by DLP 3D printer asiga pico 39 (Asiga, Australia) in a cooled (ice-water circulation) monomer bath, for printing the ink in a temperature of maximum 5° C. After printing, the 3D object was kept in a sealed vessel at 60° C. for 24 h for further gelation, then kept in an open vessel at 60° C. for 48 h for removal of solvents.

The organic residue was remove by heating to 800° C. for 1 h, at a heating rate of 0.6° C./min

### Example 24: A Method for Making a Printable 3D Transparent Silica Glass

An ink formulation was prepared by forming a siloxane oligomer with acrylic groups by the sol gel technique. First by hydrolyzing TEOS mixed with hybrid alkoxide-acrylic monomer for 1 h, followed by condensation.

20 grams of ink formulation is prepared by mixing in iced-water bath 8.01 gr of tetraethyl orthosilicate (TEOS, Acros) with 3 gr of acidic 65 wt % ethanol in water solution (0.3 wt % of HNO₃ in ethanol solution) for 30 min. After 30 min 2.67 gr of APTMS and 0.053 gr of TPO was added to the solution for addition of 60 min mixing. Then 6.34 gr of basic 65 wt % ethanol in water solution (1.5 wt % of ammonium acetate (sigma Aldrich) in ethanol solution) was added for condensation and mixed for addition 20 min. This formulation was printed by DLP 3D printer asiga 2 (Asiga, Australia) After printing, the 3D object was kept in a sealed vessel at 60° C. for 24 h for further gelation, then kept in an open vessel at 60° C. for 48 h for removal of solvents. The organic residue was removed by heating to 800° C. for 1 h, at a heating rate of 0.6° C./min

### Example 25: A Method for Making a Printable 3D Transparent Silica Glass Structure

An ink formulation was prepared by forming a siloxane oligomer with acrylic groups by the sol gel technique. First by hydrolyzing TEOS mixed with hybrid alkoxide-acrylic monomer for 1 h, followed by condensation.

20 grams of ink formulation is prepared by mixing 9.61 gr of tetraethyl orthosilicate (TEOS, Acros) with 3 gr of acidic 65 wt % ethanol in water solution (0.3 wt % of HNO₃ in ethanol solution) for 30 min. After 30 min 1.07 gr of APTMS and 0.053 gr of TPO was added to the solution for addition of 60 min mixing. Then 6.34 gr of basic 65 wt % ethanol in water solution (1.5 wt % of ammonium acetate (sigma Aldrich) in ethanol solution) was added for condensation and mixed for addition 70 min. This formulation was cured in a mold under UV LED for 20 sec. After curing, the 3D object was kept in a sealed vessel at 60° C. for 24 h for further gelation, then kept in an open vessel at 60° C. for 48 h for removal of solvents. The organic residue was remove by heating to 800° C. for 1 h, at a heating rate of 0.6° C./min. It may be noted that the cured structures after treatment at 800° C. remained transparent.

### Example 26: A Method for Making a Printable 3D Borosilicate Glass Structure

An ink formulation was prepared by forming a siloxane oligomer with acrylic groups by the sol gel technique with boric acid and sodium carbonate to achieve borosilicate glass. First by hydrolyzing with TEOS and boric acid mixed with hybrid alkoxide-acrylic monomer for 1 h, followed by condensation with sodium carbonate.

20 grams of ink formulation is prepared by mixing 8.54 gr of tetraethyl orthosilicate (TEOS, Acros) with 3 gr of acidic water solution (9 μL of HNO₃ and 1 gr of boric acid in 3 gr of water) for 30 min. After 30 min 2.14 gr of APTMS and 0.053 gr of TPO was added to the solution for addition of 60 min mixing. Then 6.34 gr of basic water solution (0.11 gr of sodium carbonate in 6.24 gr of water) was added for condensation and mixed for 10 min. This formulation was cured in a mold under UV LED for 20 sec. After curing, the 3D object was kept in a sealed vessel at 60° C. for 24 h for further gelation, then kept in an open vessel at 60° C. for 48 h for removal of solvents. The organic residue was remove by heating to 800° C. for 1 h, at a heating rate of 0.6° C./min then continue for additional heating of 850° C. for 24 h and 950° C. for 24 h.

1.-57. (canceled)

58. A formulation for 3D printing, the formulation being in the form of a solution, comprising:
a plurality of polymerizable ceramic precursors of the structure A-B, wherein:
A is a ceramic precursor moiety, and
B is at least one photopolymerizable group;
B is associated with or bonded to A via a chemical bond;
at least one photoinitiator;
optionally a plurality of non-photopolymerizable ceramic precursors; and
optionally at least one liquid organic carrier,
the formulation being free of particulate materials.

59. The formulation according to claim 58, wherein the particulate materials are selected from ceramic particles.

60. The formulation according to claim 58, wherein the polymerizable ceramic precursor is in a form selected from monomers, oligomers and pre-polymers of at least one ceramic material.

61. The formulation according to claim 58, wherein A is a monomer or an oligomer thereof selected from tetraethyl orthosilicate, tetramethyl ortosilicate, tetraisopropyltitanate, trimethoxysilane, triethoxysilane, trimethyethoxysilane, phenyltriethoxysilane, phenylmethyldiethoxy silane, methyldiethoxysilane, vinylmethyldiethoxysilane, TES 40; polydimethoxysilane, polydiethoxysilane, polysilazanes, titanium isopropoxide, aluminum isopropoxide, zirconium propoxide, triethyl borate, trimethoxyboroxine diethoxysiloxane-ethyltitanate, titanium diisopropoxide bis(acetylacetonate), silanol poss, aluminium tri-sec-butoxide, triisobutylaluminium, aluminium acetylacetonate, 1,3,5,7,9-pentamethylcyclo pentasiloxane, poly(dibutyltitanate) oligomers of siloxane, and oligomers of Al—O—Al, oligomers of Ti—O—Ti and/or Zn—O—Zn.

62. The formulation according to claim 58, wherein B is at least one photopolymerizable group selected to undergo light-induced polymerization.

63. The formulation according to claim 62, wherein B is selected from amines, thiols, amides, phosphates, sulphates, hydroxides, alkenes and alkynes.

64. The formulation according to claim 62, wherein B is selected from organic moieties comprising one or more double or triple bonds.

65. The formulation according to claim 64, wherein the organic moiety is selected from acryloyl groups, methacryloyl groups and vinyl groups.

66. The formulation according to claim 62, wherein B is selected from epoxy groups and thiol group.

67. The formulation according to claim 61, wherein A is modified by (1) amines, thiols, amides, phosphates, sulphates, hydroxides, epoxy, alkenes or alkynes, (2) alkenyl groups, or (3) acryloyl groups, methacryloyl groups, vinyl groups, epoxy group and thiol group.

68. The formulation according to claim 58, wherein the polymerizable ceramic precursors of the structure A-B are selected from (acryloxypropyl)trimethoxysilan (APTMS), 3-glycidoxypropyl methyldiethoxysilane, acryloxymethyltrimethoxysilane, (acryloxymethyl)phenethyl trimethoxysilane, (3-acryloxypropyl)trichlorosilane, 3-(n-allylamino)propyltrimethoxy silane, m-allylphenylpropyltriethoxysilane, allyltrimethoxysilane, 3-glycidoxypropylmethyl diethoxysilane, 3-glycidoxypropyl methyldiethoxysilane and POSS acrylates.

69. The formulation according to claim 68, wherein the polymerizable ceramic precursors of the structure A-B are selected from (acryloxypropyl)trimethoxysilan (APTMS) and POSS acrylates.

70. The formulation according to claim 58, wherein the non-photopolymerizable ceramic precursors are selected from tetraethoxyorthosilicate, tetraisopropyltitanate, trimethoxysilane, polydiethoxysilane, polydimethoxysilane, polysilazanes triethoxy silane, trimethyethoxysilane, phenyltriethoxysilane, phenylmethyldiethoxysilane, methyl diethoxysilane, TES 40, tetraethyl orthosilicate (TEOS), titanium isopropoxide, aluminum isopropoxide, zirconium propoxide, triethyl borate, trimethoxyboroxine diethoxysiloxane-ethyltitanate, titanium diisopropoxide bis(acetylacetonate), silanol POSS, aluminium tri-sec-butoxide, triisobutylaluminium, aluminium acetylacetonate, 1,3,5,7,9-pentamethylcyclopentasiloxane, poly(dibutyl titanate) oligomers of siloxane, oligomers of Al—O—Al, and oligomers of Ti—O—Ti and/or Zn—O—Zn.

71. The formulation according to claim 58, comprising one or more oligomers of siloxane or oligomers with Al—O—Al or Ti—O—Ti backbones.

72. A process for forming a 3D ceramic object or a ceramic pattern, the process comprising irradiating at least one polymerizable ceramic precursor of the formula A-B or a formulation comprising same, at a temperature below 90° C.,
wherein in the at least one polymerizable ceramic precursor of the formula A-B:
A is a ceramic precursor moiety, and
B is at least one photopolymerizable group; such that B is associated with or bonded to A via a chemical bond,
and wherein the at least one polymerizable ceramic precursor of the formula A-B or a formulation comprising same is provided on a substrate or in a printing bath.

73. The process according to claim 72, comprising:
applying a formulation comprising at least one polymerizable ceramic precursor of the general formula A-B on a surface region of a substrate, the application being carried out at a temperature below 90° C., and under irradiation of UV light, the process optionally comprising further treatment of the formed object or pattern.

74. The process according to claim 73, the process comprising:
a) forming a pattern of a formulation on a surface region of a substrate or on a previously formed pattern; the formulation comprising at least one polymerizable ceramic precursor of the formula A-B;
b) affecting polymerization of at least a portion of the polymerizable moieties present in the at least one polymerizable ceramic precursors at a temperature below 90° C.;
c) repeating steps (a) and (b) one or more times to obtain the 3D object/pattern; and
d) optionally performing a post printing process including one or more of aging the 3D object/pattern at room temperature, immersing the 3D object/pattern in an acid, a base or an electrolyte solution followed by heating at a temperature above 100° C. to obtain a ceramic or glass object.

75. The process according to claim 72, the process comprising:
a) forming a pattern of a formulation on a surface region of a substrate or on a previously formed pattern; the formulation comprising at least one polymerizable ceramic precursor of the formula A-B;
b) affecting polymerization of at least a portion of the polymerizable moieties present in the at least one polymerizable ceramic precursors at a temperature below 90° C.;
c) repeating steps (a) and (b) and one or more times to obtain a 3D object/pattern; and
d) optionally performing a post printing process including one or more of aging the 3D object/pattern at room temperature, immersing the 3D object/pattern in an acid, a base or an electrolyte solution followed by heating at a temperature above 100° C. to obtain a ceramic or glass object.

76. The process according to claim 72, the process comprising:
a) placing an ink formulation comprising at least one polymerizable ceramic precursor of the formula A-B within a printer bath;
b) affecting polymerization of at least a portion of the polymerizable moieties present in the at least one polymerizable ceramic precursor at a temperature below 90° C. by irradiating the formulation in said bath to form a polymeric layer;
c) repeating step (b) one or more times to obtain a 3D object with a predefined, height and size; and
d) optionally performing a post printing process including, but not limited to, aging the 3D object/pattern at room temperature, immersing the 3D object/pattern in acid or base or electrolyte solution followed by heating at a temperature above 100° C. to obtain a ceramic or glass object.

77. The process according to claim 72, further comprising a step of burning or heating the formed 3D object or pattern to a temperature above 100° C.
